(19) United States
(12) Patent Application Publication
(10) Pub. No.: US 2016/0328703 A1
(43) Pub. Date: Nov. 10, 2016

(54) DIGITAL MARKETPLACE FOR CASINO APPLICATIONS

(71) Applicant: Betcade LLC, San Mateo, CA (US)

(72) Inventors: David Barbarino Chang, San Meteo, CA (US); Trevor Alan Fiatal, Fremont, CA (US)

(21) Appl. No.: 15/096,197

(22) Filed: Apr. 11, 2016

Related U.S. Application Data
(60) Provisional application No. 62/145,432, filed on Apr. 9, 2015.

(51) Int. Cl. G06Q 20/36; G06F 3/0482; G06Q 20/10

(52) U.S. Cl. CPC G06Q 20/3672; G06Q 20/102; G06F 3/0482

(57) ABSTRACT

The invention comprises an application marketplace intended to aggregate real-money casino applications for Android, iOS, Windows Mobile, and any other suitable mobile ecosystem. The marketplace moderates and manages promotions for specific casino applications. The marketplace moderates and manages time-based promotions for live events, offers, casino offers, and specific casino applications. The marketplace incorporates a system for making in-application deposits, with consistent access to stored payment methods across casino applications and centralized access to billing transaction records. The marketplace links a store application or website to an embedded software element (SDK) within third-party casino applications which facilitates both application management and deposit of funds into casino applications. The marketplace personalizes user experience in ways specific to gambling based on declared preferences, observed consumer behavior, and individual or cohort deposit patterns within and across casino applications or categories of casino applications.

### CROSS REFERENCE TO RELATED APPLICATIONS

This application claims the benefit of U.S. Provisional Application No. 62/145,432, filed Apr. 9, 2015, which is incorporated herein in its entirety by reference for all purposes.

### FIELD OF THE INVENTION

The invention relates generally to the management and distribution of mobile applications. The invention more specifically relates to the management of currency between a plurality of gambling applications.

### BACKGROUND

Smartphones or modern cell phones often include mobile applications. Mobile applications are purchased, managed, and updated by marketplace or store application. Present marketplace applications disallow casino applications and are accordingly not structured to accommodate such applications. Therefore there is a need for an application marketplace which manages casino applications.

### INCORPORATION BY REFERENCE

The following disclosures are incorporated by reference in their entirety and for all purposes to the same extent as if the patent application was specifically reprinted in this specification: United States patent U.S. patent application Ser. No. 10/988,304, filed Nov. 12, 2004), titled “System and method for downloading or enabling download of a program from a program store location”; U.S. patent application Ser. No. 13/495,571, filed Jun. 13, 2012, titled “Enterprise mobile application store”; U.S. Pat. No. 8,832,817, filed Jul. 19, 2012, titled “Application marketplace administrative controls”; and U.S. Pat. No. 7,802,294, filed Jan. 28, 2005, titled “Controlling computer applications' access to data.”

### SUMMARY

Embodiments of the invention comprise an application marketplace or a casino marketplace intended to aggregate real-money casino applications for Android, iOS, Windows Mobile, and any other suitable mobile ecosystem. The marketplace moderates and manages promotions for specific casino applications. The marketplace additionally manages actual money or digital chips in a shared digital wallet.

### BRIEF DESCRIPTION OF THE DRAWINGS

Embodiments of the present invention will be described and explained through the use of the accompanying drawings in which:

FIG. 1 is a diagram of a marketplace application network configuration;

FIG. 2 is a flowchart illustrating a method of operation for a casino marketplace;

FIG. 3 is a flowchart illustrating a method of promoted casino applications;

FIG. 4 is a sequence diagram illustrating example transactions in connection with an embodiment in which information relating to a user's newly-added financial card is not saved in the user's account;

FIG. 5 is a sequence diagram illustrating example transactions in connection with an embodiment in which information relating to a user's newly-added financial card is saved in the user's account;

FIG. 6 is a sequence diagram illustrating example transactions in connection with an embodiment in which information relating to a user's financial card is added to the user's account;

FIG. 7 is a sequence diagram illustrating example transactions in connection with an embodiment in which information relating to a user's existing financial card is saved in the user's account;

FIGS. 8A-8C are illustrating betting on real life events in real time;

FIGS. 9A and 9B are screenshots illustrating various segments of the casino marketplace, and promotions associated with these segments;

FIGS. 10A-10D are screenshots illustrating various mechanisms of resetting a pin associated with a user's account;

FIGS. 11A-11C are screenshots illustrating promotion codes for time-based promotions;

FIG. 12 is a screenshot illustrating a user's casino marketplace account;

FIGS. 13A-13D are screenshots illustrating a user's preferences and casino applications associated with sport events; and

FIG. 14 illustrates an example of a computer system with which some embodiments of the present disclosure may be utilized.

### DETAILED DESCRIPTION

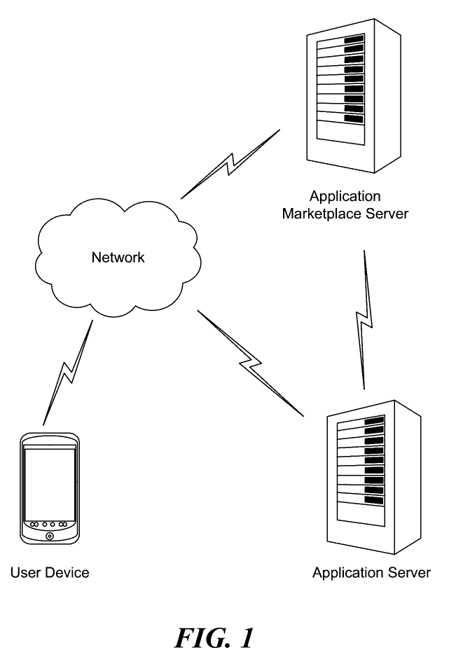

FIG. 1 is a diagram of a marketplace application network configuration. Users have mobile devices which communicate with a network such as the Internet. To obtain a marketplace application (“marketplace”), a user directs a mobile device to download the marketplace. Alternatively, the user makes use of a computer to first download the marketplace and then transfers the marketplace to the user's mobile device for installation. The marketplace software is supported by a marketplace server which communicates to the mobile device via the Internet. The marketplace application is alternatively referred to herein as the casino marketplace.

Through use of the marketplace, the mobile device communicates to application servers. Application servers support casino application software (“casino apps”). Mobile devices in communication with the marketplace request casino apps from application servers which are loaded onto the mobile device. Marketplace servers provide updates to casino software as available to the mobile device.

The marketplace has a user interface on the mobile device. The user interface present casino apps to the user of the mobile device. The presented casino apps are either available for downloaded or are already existing on the user device. While feasibly a casino existing on the mobile device may be accessed separately, the marketplace provides functionality for the mobile device to execute the casino from within the marketplace.

In some embodiments application servers will submit their casino apps to the marketplace for download. In other embodiments the marketplace scans the Internet for available casino apps and makes these casino apps available for download to mobile devices. Casino companies may provide or submit their casino apps to the marketplace for review and publication.

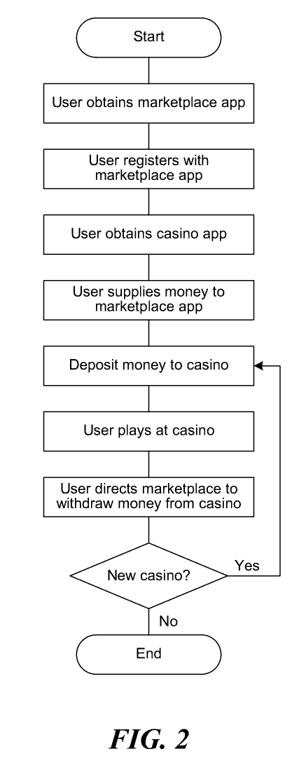

FIG. 2 is a flowchart illustrating a method of operation for a casino marketplace. First, a user obtains the marketplace. Then, the user registers an account. Account registration requires identifying information such as a credit card, a third party social account, an email address, or any other identifying information that is enabled to be verified out of band. Once a user is registered with the marketplace, the user obtains one or more casino applications from the marketplace. The user then supplies a verified payment method to the marketplace. The marketplace uses this payment method to process payments for immediate deposit into one or more digital wallets held by the casinos in the user's name. The monetary deposit is processed through means including but not limited to standard debit/credit transactions, electronic bank drafts, third-party alternative payment services, or through a transfer from another digital wallet.

According to one embodiment, once the user has money on the marketplace, the user chooses a casino to send the money to. The marketplace server communicates with the application server and indicates the presence of funds in the user's name. The user is enabled to play games at that casino with the indicated funds. Should the user spend some or all of the funds at the casino, the marketplace server deposits the appropriate funds in an account of the application server's direction. In certain embodiments, the marketplace retains a transaction fee from the funds before depositing at the direction of the application server.

In another embodiment, when the user has finished playing games at the casino, the user directs any remaining funds to be removed from allocation to the casino and back into the marketplace account. In the circumstance where the user has obtained more funds than the user began with, the marketplace requests funds from an account the application server indicates. In certain embodiments the marketplace server retains a transaction fee from the requested funds.

In a further embodiment, the user is then enabled to direct funds from the marketplace account to allocate towards a different casino. In this way, the marketplace treats the individual casino applications as if each were a “table” in a physical casino that the user may “sit down” and “get up from” at will.

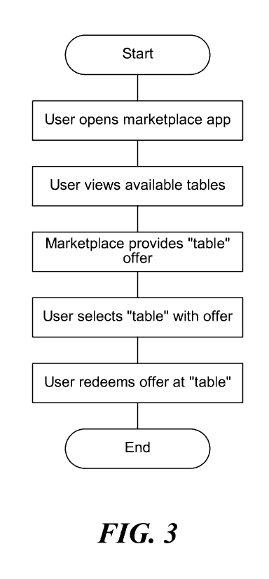

FIG. 3 is a flowchart illustrating a method of promoted casino applications. The invention enables users to make use of a secondary kind of currency: chips. Chips function as money; however, chips are not collectable as money until the chip has first been bet at a casino. In some embodiments, users are enabled to buy chips directly from the marketplace and use the chips instead of money. Embodiments of chips include additional rules such as modified odds in casino apps. For illustrative purposes, if a game normally pays 2:1, a user who bets chips would instead of money receive a 3:1 payment. In other embodiments a third kind of currency is available: tokens. Tokens have no monetary value and are usable to provide zero monetary risk, and zero monetary reward method of playing at casino apps.

In use, a user first opens the marketplace on the mobile device. The user views available casino apps or “tables” the user has accessible on the mobile device. The marketplace provides a promotional offer to one or more of the tables. Promotional offers comprise free or discounted chips at a specific or group of casino apps. In certain embodiments promotional offers comprise additional special rules applied to chips that do not apply at other casino apps.

A user then selects a casino or “table” with and redeems the promotional offer by satisfying the conditions of the offer at the casino. The marketplace manages promotional offers with partner agreements with the casino apps. Partner agreements comprise adjusted transaction fees in return for additional exposure. In some embodiments promotional offers are unilaterally controlled by the marketplace.

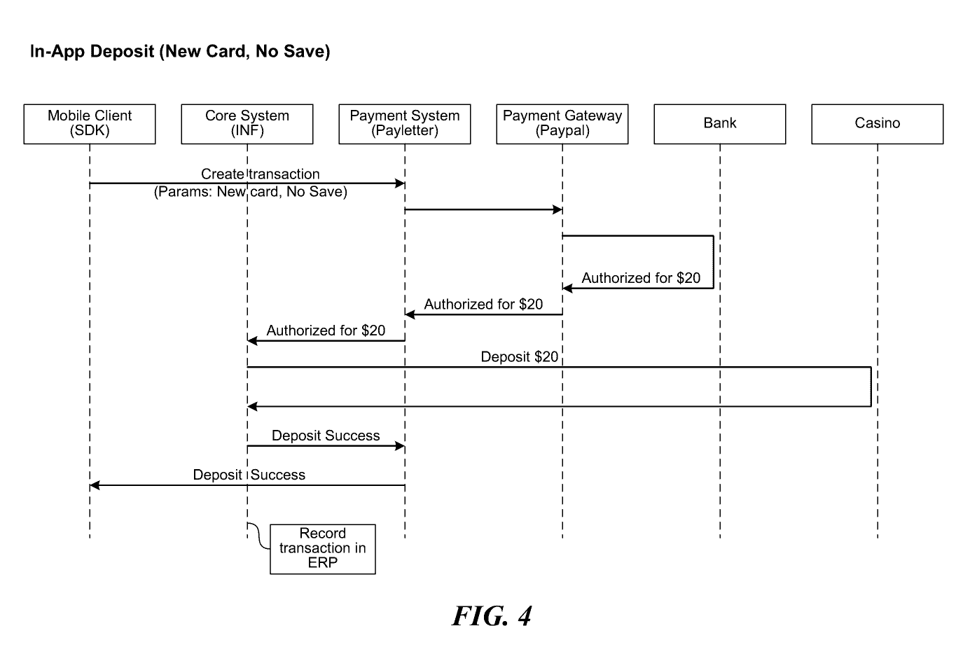

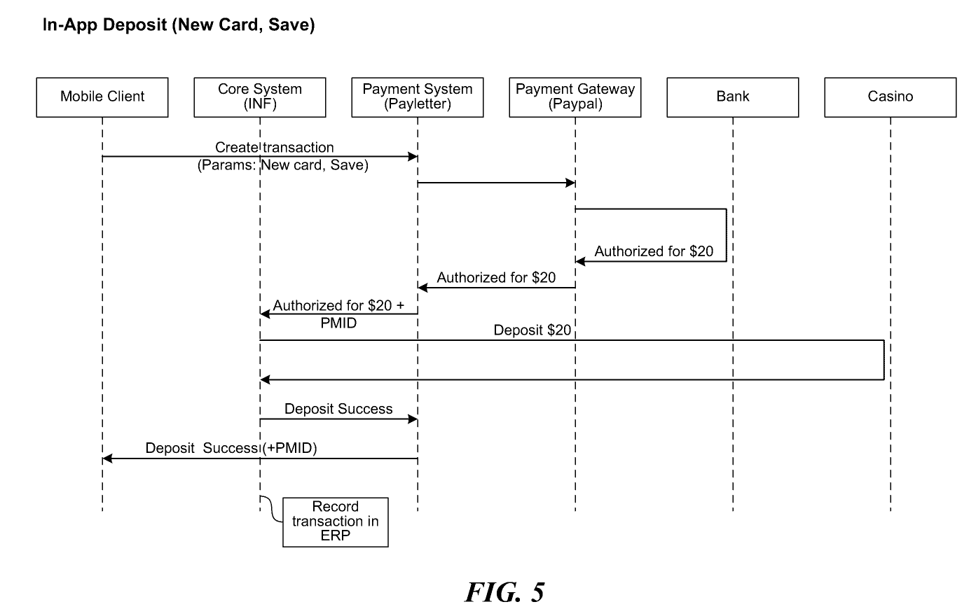

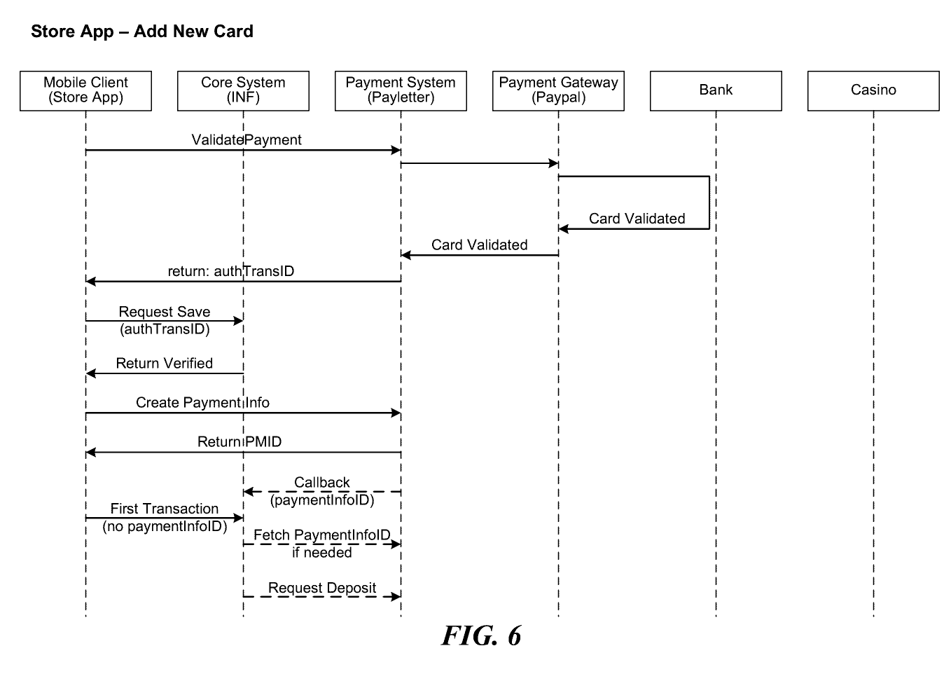

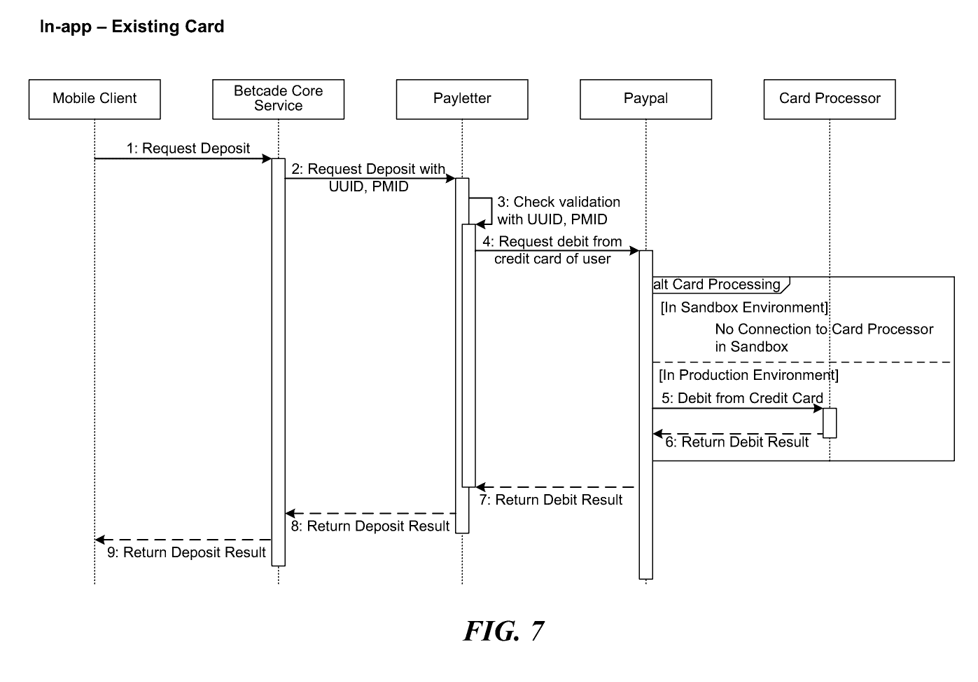

FIGS. 4-7 are sequence diagrams illustrating process flows of methods of operation for various embodiments of the casino marketplace. According to disclosed embodiments, functionalities of the mobile client (SDK), the Core System (INF), and the Payment System (e.g., Payletter) are provided by an entity hosting the application marketplace. The mobile client (SDK) runs on a device of the user such as a smart phone or a tablet. The Core System and the Payment System run on one or more physical, virtual, or cloud servers hosting the application marketplace. For example, FIG. 4 depicts a sequence of example transactions in connection with an embodiment in which information relating to a user's newly-added financial card (e.g., a credit card or a debit card) is not saved in the user's account (e.g., at the user's mobile device and/or the server). FIG. 5 depicts a sequence of example transactions in connection with an embodiment in which information relating to a user's newly-added financial card (e.g., a credit card or a debit card) is saved in the user's account. FIG. 6 depicts a sequence of example transactions in connection with an embodiment in which information relating to a user's financial card (e.g., a credit card or a debit card) is added to the user's account. FIG. 7 depicts a sequence of example transactions in connection with an embodiment in which information relating to a user's existing financial card (e.g., a credit card or a debit card) is saved in the user's account. In the FIG. 7 embodiment, the processing of the financial card can take place in a secure (e.g., “sandbox”) environment.

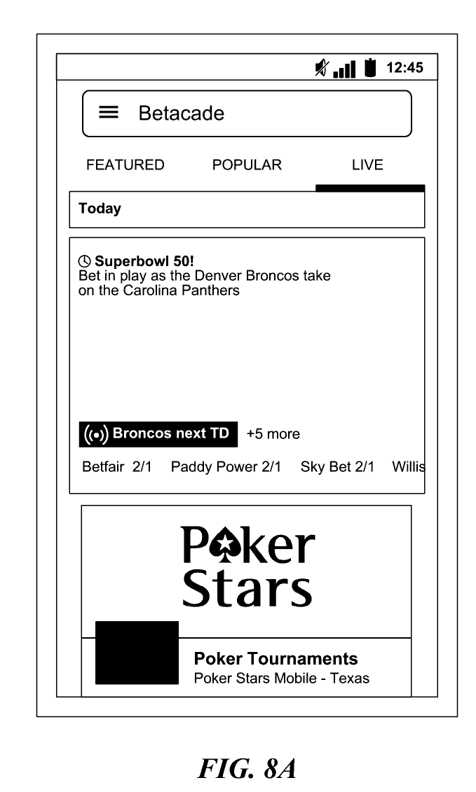

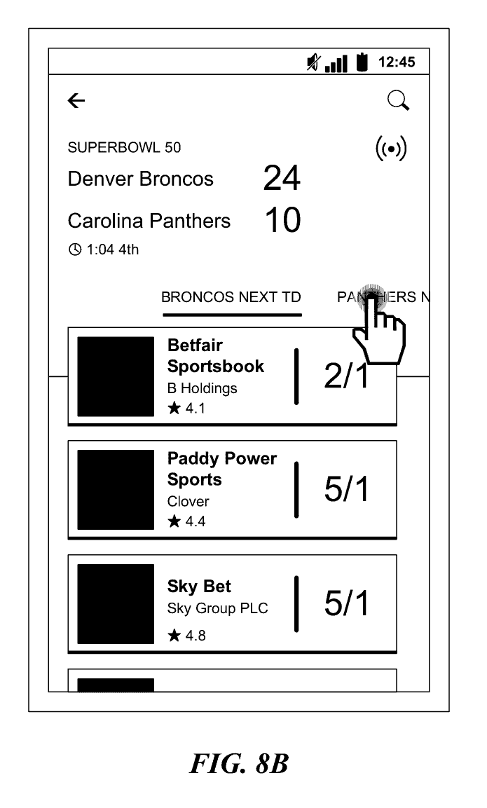

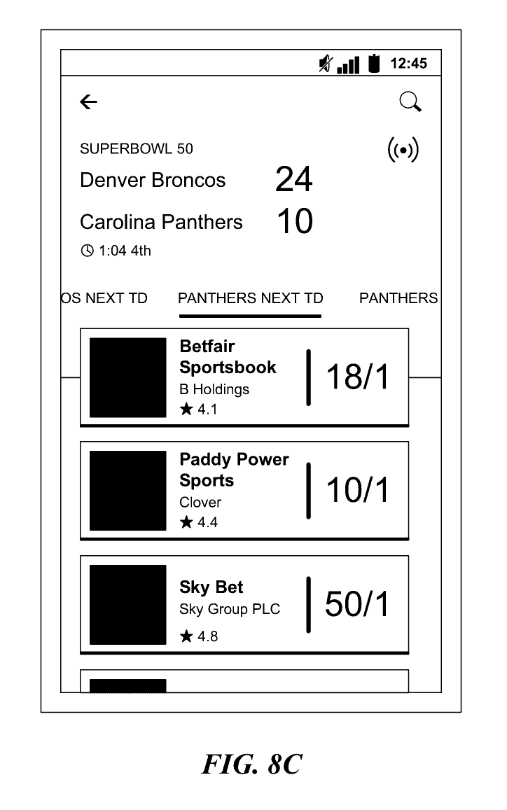

FIGS. 8A-8C are screenshots illustrating betting on real life events in real time. For example, FIGS. 8A-8C show scores in a Superbowl played between the Denver Broncos and the Carolina Panthers. Also shows are various third-party casino applications (available at the casino marketplace) such as “Betfair Sportsbook,” “Paddy Power Sports,” and “Sky Bet”. Examples of real life events include “Panthers Next Touchdown,” “Broncos Next Touchdown,” etc. FIGS. 8B and 8C also show the bets associated with these real life events, the bets being offered by the third-party casino applications.

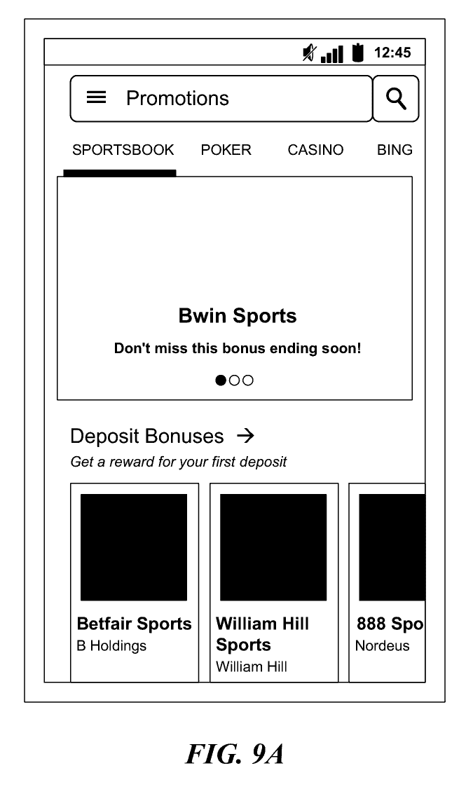

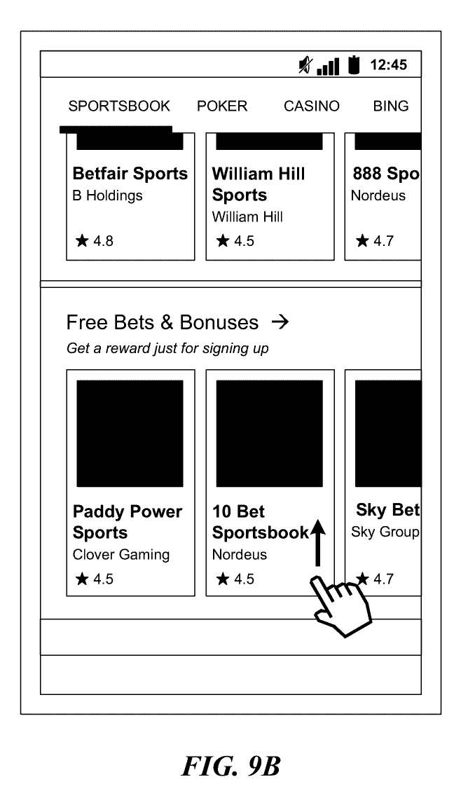

FIGS. 9A and 9B illustrate screenshots showing various segments of the casino marketplace, and promotions associated with these segments. The segments correspond to a category or type of casino application. Examples of such segments are Sportsbook, Poker, Casino, and Bingo. The promotions included in the Sportsbook segment are Deposit Bonuses and Free Bets and Bonuses. In a Deposit Bonus, a user gets a reward for his or her first deposit. In a Free Bets and Bonus, a user gets a reward for signing up with a casino application. Examples of casino applications are Betfair Sports, William Hill Sports, Paddy Power Sports, 10 Bet Sportsbook, etc.

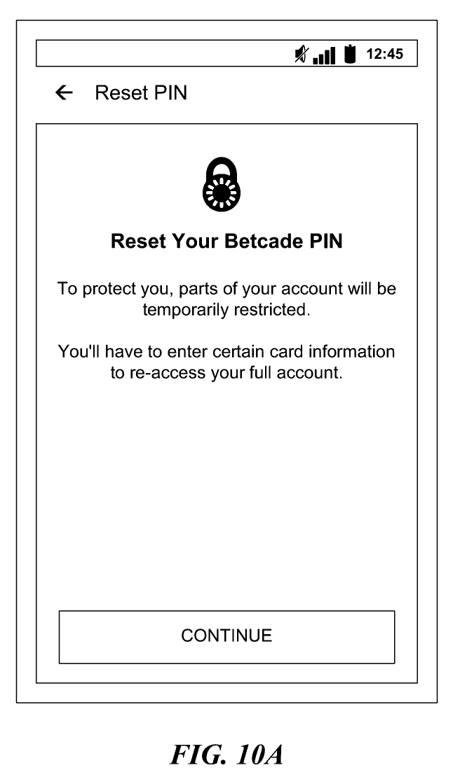

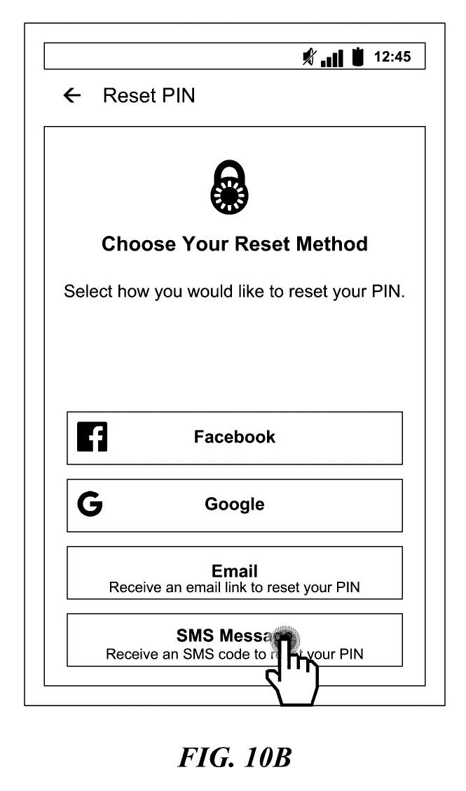

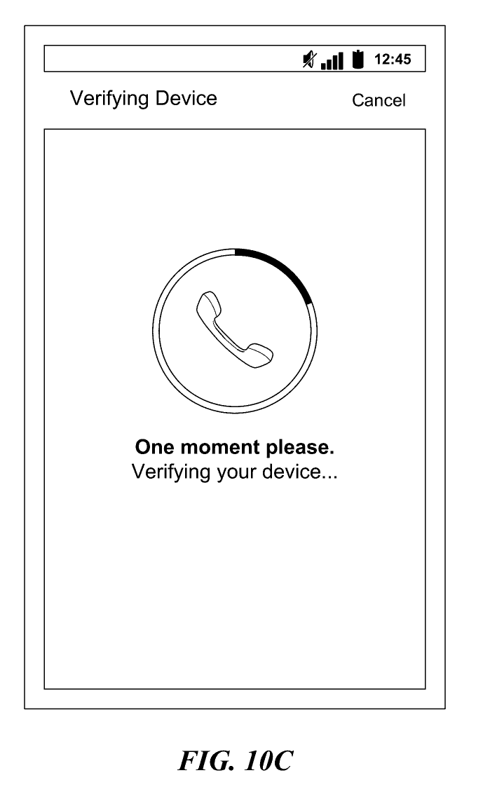

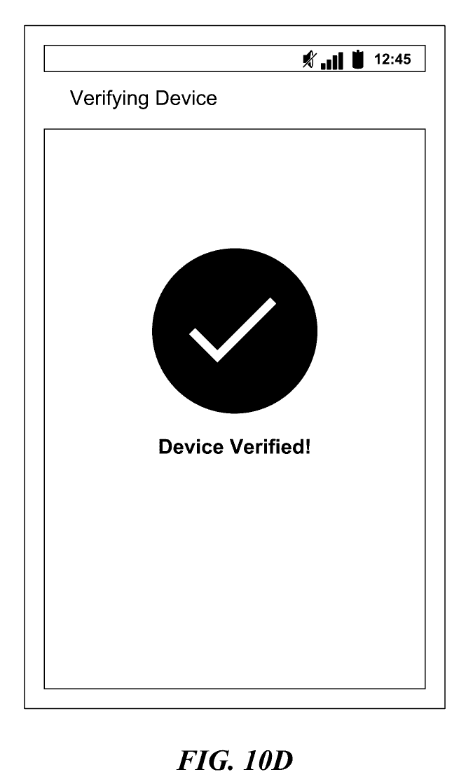

FIGS. 10A-10D illustrate screenshots showing various mechanism of resetting a pin associated with a user's account. For example, a pin can be reset via one or more social media network of the user, an email message including a link, or a text message including a code to reset the pin. The email message or the text message can be sent by a server associated with the casino marketplace. After receiving the text message that includes the code, the user can enter the code via the graphical user interface of the casino marketplace app. Upon receiving the code, the application marketplace verifies the user's device.

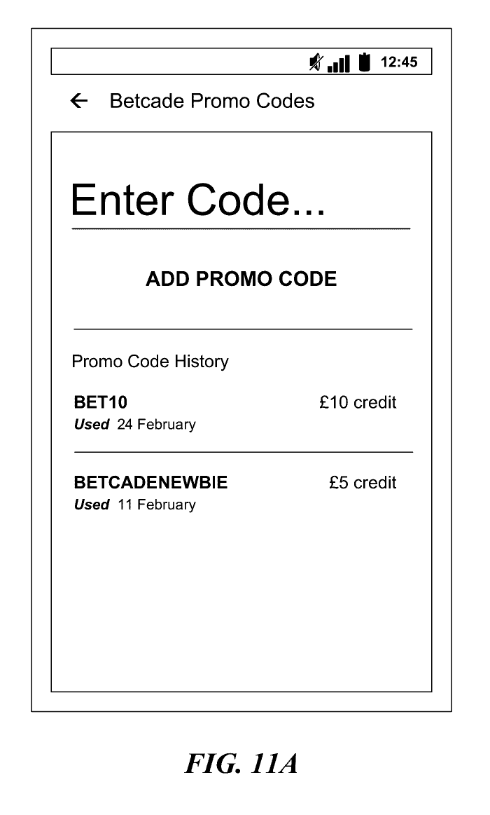

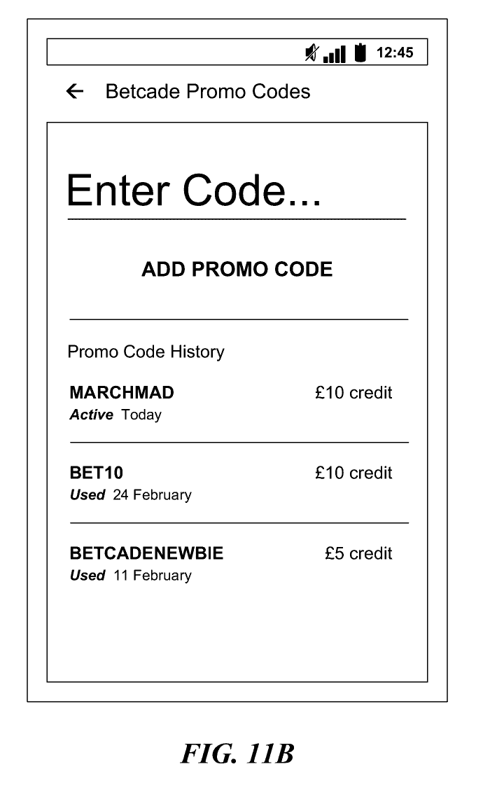

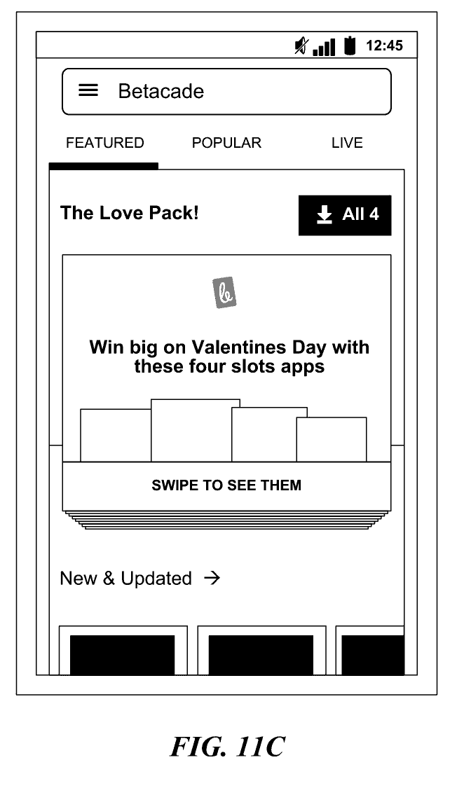

FIGS. 11A-11C illustrate screenshots showing promotion codes for time-based promotions. For example, FIG. 11 B indicates that the “MARCHMAD” promotion code is only valid today. FIG. 11C indicates gambling applications (e.g., slots) that are available on Valentine's Day.

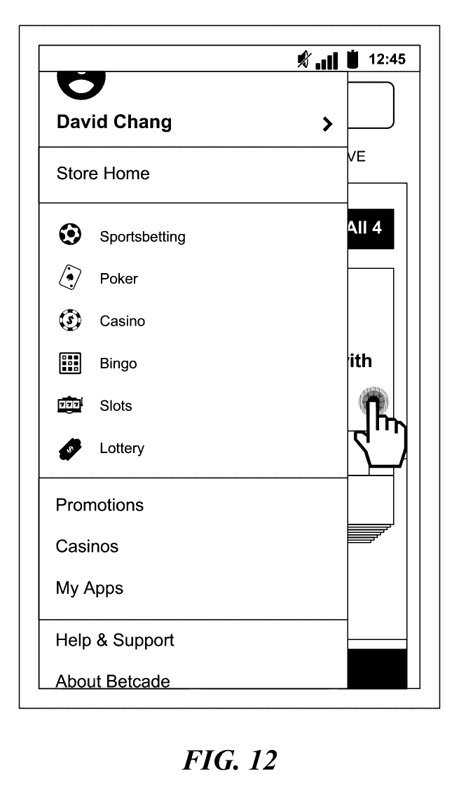

FIG. 12 illustrates a screenshot showing a user's casino marketplace account. For example, a user “David Chang” can download different types of gambling applications from the casino marketplace. Examples of types or segments of gambling applications can be sportsbetting, poker, casino, bingo, slots, and lottery.

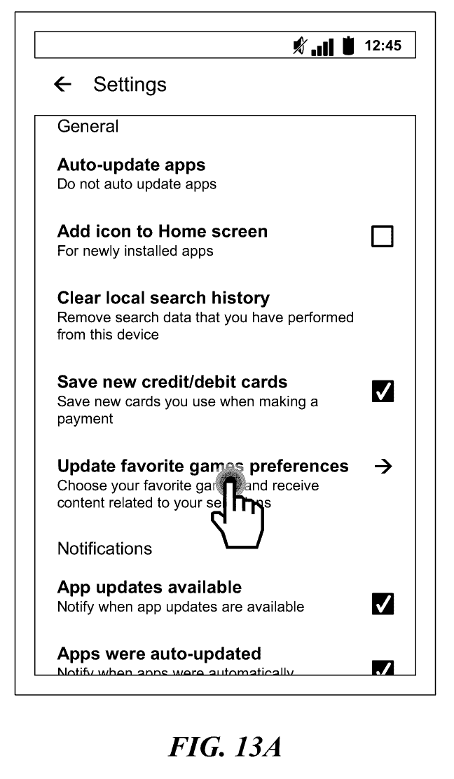

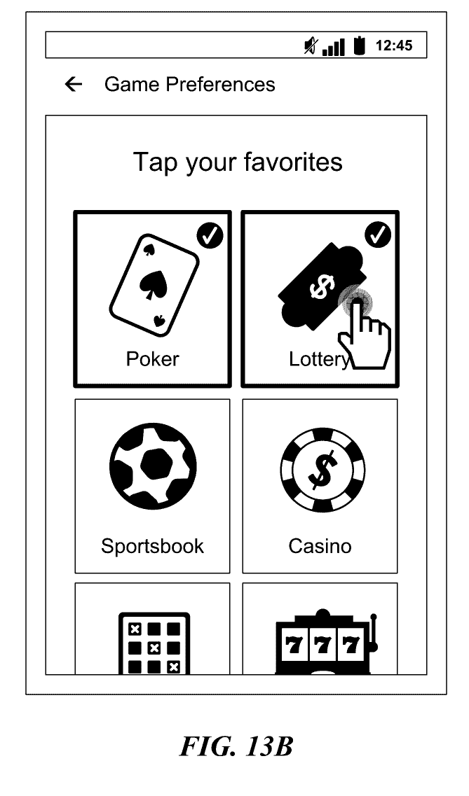

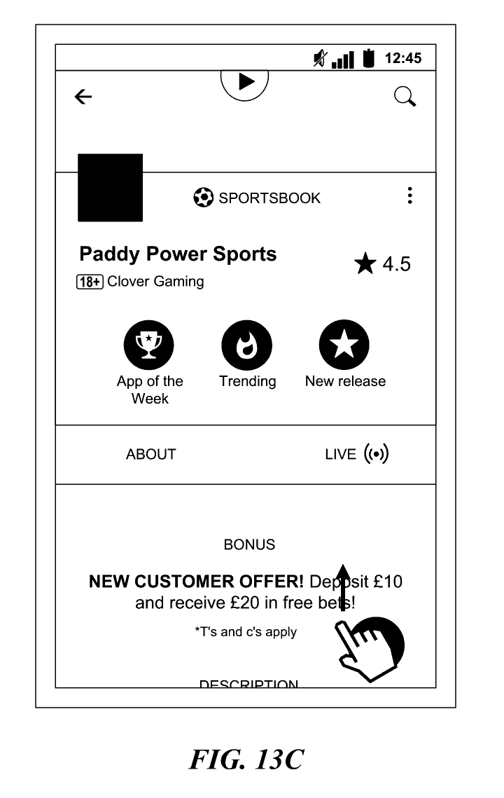

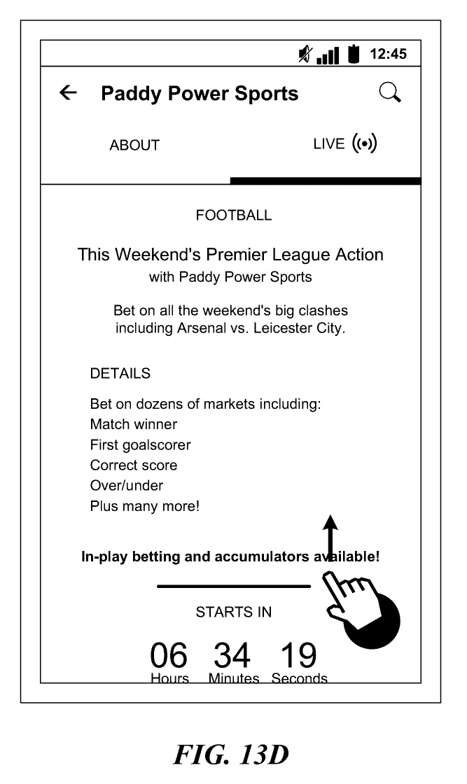

FIGS. 13A-13D illustrate screenshots associated with a user's preferences and casino applications associated with sport events. For example, FIGS. 13A and 13B display game or gambling application preferences of a user. The user can also browse through different sections, with added priority to those categories of applications that the user has elected as favorite categories. FIG. 13C depicts an example promotional offer available to a new customer or user, offered by a casino called “Paddy Power Sports.” In some embodiments, users can rate a casino in the application marketplace. For example, Paddy Power Sports has a user rating of 4.5. FIG. 13D illustrates that Paddy Power Sports provides a sportsbetting application for a weekend soccer match (e.g., Premier League) in which the betting starts in 6 hours 34 minutes 19 seconds according to a system clock running on the application marketplace.

### Computer System Overview

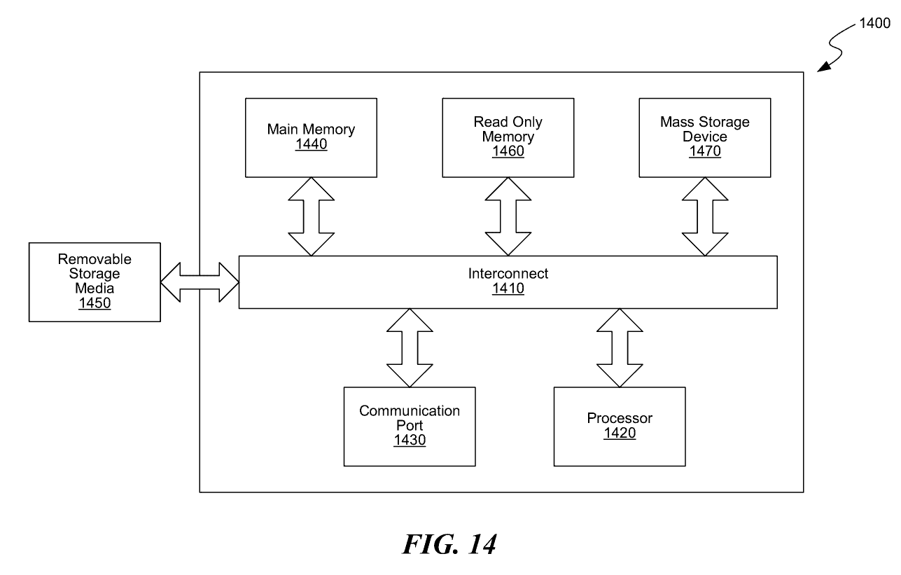

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 14 is an example of a computer system 1400 with which embodiments of the present disclosure may be utilized. According to the present example, the computer system includes an interconnect 1410, at least one processor 1420, at least one communication port 1430, a main memory 1440, a removable storage media 1450, a read only memory 1460, and a mass storage device 1470.

Processor(s) 1420 can be any known processor, such as, but not limited to, an Intel® Itanium® or Itanium 2® processor(s), or AMD® Opteron® or Athlon MP® processor(s), or Motorola® lines of processors. Communication port(s) 1430 can be any of an RS-232 port for use with a modem-based dialup connection, a 10/100 Ethernet port, or a Gigabit port using copper or fiber. Communication port(s) 1430 may be chosen, depending on a network such as a Local Area Network (LAN), Wide Area Network (WAN), or any network to which the computer system 1300 connects.

Main memory 1440 can be Random Access Memory (RAM) or any other dynamic storage device(s) commonly known in the art. Read only memory 1460 can be any static storage device(s) such as Programmable Read Only Memory (PROM) chips for storing static information, such as instructions for processor 1420.

Mass storage 1470 can be used to store information and instructions. For example, hard disks such as the Adaptec® family of SCSI drives, an optical disc, an array of disks such as RAID, the Adaptec family of RAID drives, or any other mass storage devices may be used.

Interconnect 1410 communicatively couples processor(s) 1420 with the other memory, storage, and communication blocks. Interconnect 1410 can be a PCI/PCI-X- or SCSI-based system bus, depending on the storage devices used.

Removable storage media 1450 can be any kind of external hard-drives, floppy drives, IOMEGA® Zip Drives, Compact Disc—Read Only Memory (CD-ROM), Compact Disc—Re-Writable (CD-RW), or Digital Video Disc—Read Only Memory (DVD-ROM).

The components described above are meant to exemplify some types of possibilities. In no way should the aforementioned examples limit the disclosure, as they are only exemplary embodiments.

### Terminology

Brief definitions of terms, abbreviations, and phrases used throughout this application and the appendices are given below.

The terms “connected” or “coupled” and related terms are used in an operational sense and are not necessarily limited to a direct physical connection or coupling. Thus, for example, two devices may be coupled directly or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean that the particular feature, structure, or characteristic following the phrase is included in at least one embodiment of the present disclosure and may be included in more than one embodiment of the present disclosure. In addition, such phrases do not necessarily refer to the same embodiments or to different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs) interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks, as one skilled in the art will appreciate. As such, the illustrated applications of the embodiments of the present disclosure are not meant to be limiting, but instead are examples. Other systems, devices, and networks to which embodiments of the present disclosure are applicable include, but are not limited to, other types of communication and computer devices and systems. More specifically, embodiments are applicable to communication systems, services, and devices such as cell phone networks and compatible devices. In addition, embodiments are applicable to all levels of computing, from the personal computer to large network mainframes and servers.

In conclusion, the present disclosure discloses novel systems, methods, and arrangements for developing an automated life planner. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

1. A method comprising:
providing a marketplace application for download and operation on mobile operating platforms, the marketplace application managing a plurality of casino applications;
receiving monetary amounts from users;
depositing the monetary amounts into digital wallets associated with the users; and
allowing the users to allocate select deposited monetary amounts to selected casino applications.

2. The method of claim 1, wherein the marketplace application provides promotion codes associated with one or more casino applications in the plurality of casino applications.

3. The method of claim 2, wherein the promotion codes are automatically expire after a length of time.

4. The method of claim 2, wherein the promotion codes are for a specific gambling application in the plurality of casino applications.

5. The method of claim 1, wherein the marketplace application provides selection of one or more casino applications in the plurality of casino applications based on preferences of a user.

6. The method of claim 1, wherein the plurality of casino applications are included in one or more predefined category.

7. The method of claim 6, wherein the one or more predefined category is selected from: new, featured, poker, lottery, sportsbook, casino, slots, and bingo.

8. The method of claim 1, further comprising:
transmitting, via a server, a code to a device of a user for resetting an account of the user.

9. The method of claim 1, wherein a casino application in the plurality of casino applications displays events associated with a sport in real time.

10. The method of claim 1, wherein a casino application in the plurality of casino applications is associated with a future sport event.

11. A method comprising:
providing a marketplace application for download and operation on mobile operating platforms, the marketplace application managing a plurality of casino applications;
receiving monetary amounts from users; and
depositing the monetary amounts into digital wallets belonging to users, managed by casinos, and associated with casino applications in use by or designated by users at the time of the deposit.

12. The method of claim 11, wherein the plurality of casino applications are included in one or more predefined category, and the one or more predefined category is selected from: new, featured, poker, lottery, sportsbook, casino, slots, and bingo.

13. The method of claim 11, wherein the plurality of casino applications are included in one or more predefined category, and the one or more predefined category is selected from a list including but not limited to: new, featured, poker, lottery, sportsbook, casino, slots, and bingo.

14. The method of claim 11, wherein a casino application in the plurality of casino applications displays events associated with a promotion, tournament or competition in real time.

15. The method of claim 11, wherein a casino application in the plurality of casino applications is associated with a future promotion, tournament or competition event.

16. The method of claim 11, wherein the receiving and depositing of monetary amounts from users into digital wallets is managed independently of the marketplace by a casino or third party.

17. The method of claim 11, wherein the marketplace displays information associated with a sport event in real time.

18. The method of claim 11, wherein the marketplace displays information associated with a future sport event.

19. The method of claim 11, wherein the marketplace displays information associated with a promotion, tournament or competition in real time.

20. The method of claim 11, wherein the marketplace displays information associated with a future promotion, tournament or competition.
